(19) United States
(12) Patent Application Publication
(10) Pub. No.: US 2007/0255600 A1
(43) Pub. Date: Nov. 1, 2007

(54) METHOD AND DEVICE FOR MEDICATION MANAGEMENT

(76) Inventor: Sara Lynn Cantor, Chicago, IL (US)

Correspondence Address: BELL, BOYD & LLOYD, LLP, P.O. Box 1135, CHICAGO, IL, 60690, US

(21) Appl. No.: 11/740,443

(22) Filed: Apr. 26, 2007

Related U.S. Application Data
(60) Provisional application No. 60/746,127, filed on May 1, 2006.

(51) Int. Cl. G06F 19/00

(52) U.S. Cl. 705/3

(57) ABSTRACT

Devices for managing medication, and methods for ensuring medication compliance, ordering medication, and generating revenue from medication management devices. A device for managing medication and methods for ensuring medication compliance, ordering medication, and generating revenue from the medication management device are provided. In an embodiment, a medication compliance method is provided which includes providing a medication management device to a user, notifying the user via the medication management device that a medication should be taken, notifying the user via the medication management device that additional medication should be ordered, and allowing the user to remotely order the medication via the medication management device.

### RELATED APPLICATIONS

This patent application claims the benefit of U.S. Provisional Patent Application Ser. No. 60/746,127 filed May 1, 2006, the entire disclosure of which is fully incorporated by reference herein.

### BACKGROUND

The present invention relates generally to methods and devices for managing medication. More specifically, the present invention relates to methods for increasing medication compliance, filling medication orders, and increasing revenue using medication management devices.

Chronic diseases such as heart disease, cancer, and diabetes are the leading causes of death and disability in the United States. Every year, chronic diseases claim the lives of more than 1.7 million Americans. These diseases are responsible for seven of every ten deaths in the United States. More than 90 million Americans live with chronic illnesses, and for 25 million of those people, their illnesses cause major limitations in daily living. The medical care costs of people with chronic diseases account for more than 75% of the nation's $1.4 trillion medical care costs.

Although chronic diseases are among the most prevalent and costly health problems, they are also among the most preventable. Chronic diseases are not prevented by vaccines or generally cured by medication, nor do they just disappear. To a large degree, the major chronic disease killers, such as heart disease, cancer, stroke, and diabetes, are the result of what people do in their daily lives. Promoting healthy behavior choices, through education and community policies, is essential to reducing the burden of chronic diseases.

People suffering from chronic illnesses require ongoing prescriptions and over-the-counter medication. Such people may look to develop relationships with pharmacists to reduce the burden of obtaining medication. However, the retail pharmacy marketplace is crowded and competitive. Pharmacies have an attractive business model, because each new customer brings predictable, repeat business. Large retailers such as Wal-Mart, Kmart, and Target have all opened pharmacies in their stores. The average large retail customer visits the retailer four times a year, while the average pharmacy customer visits twelve times a year. There is economic value, therefore, in converting regular retail customers into pharmacy customers.

Generally, people must take medication correctly to stay healthy. Medication noncompliance occurs when people take the wrong medication, take the correct medication at the wrong time, skip a pill, or double-dose. Medication noncompliance is a factor in approximately 10 percent of all hospitalizations in the United States and costs the United States approximately $100 billion and 225,000 lives each year.

Taking medication on a regular basis presents several difficulties. Some people are unmotivated or lose motivation when they do not experience immediate results. Some people simply forget to take a dose of medication. Some people may not realize the adverse effects of noncompliance. Other people may find the administrative task of ordering refills from a pharmacist to be difficult.

Electronic devices which remind people or caregivers to administer medication on a regular basis are known in the art, as are devices which record compliance information. Also known are devices which deliver prescriptions from a doctor to a pharmacist. However, a need exists for a device that addresses the refill aspect of noncompliance. A device which adequately addressed refilling medication may build customer loyalty and facilitate a customer-pharmacist relationship by educating patients and caregivers and easing a customer's administrative burdens in refilling prescriptions.

### SUMMARY

The present invention relates generally to medication management devices, methods for increasing medication compliance, and methods for ordering medication. The invention also provides methods for generating revenue from the medication management devices.

In an embodiment, a method of ordering medication is provided. The method includes providing a medication management device to a user, prompting the user via the medication management device to order medication, and enabling the user to remotely order the medication via the medication management device.

In an embodiment, the method includes enabling the user to remotely order the medication by pushing a single button on the medication management device. The method, in an embodiment, includes programming the medication management device according to a preference of the user. In an embodiment, the method includes enabling the user to modify the preference. The method, in an embodiment, includes programming the medication management device with preferred medication reminder times and formats.

In an embodiment, a medication management device is provided. The medication management device includes a housing, an input, a wireless transceiver, a notification mechanism, and a medication storage area.

In an embodiment, the medication management device includes an eyelet. In an embodiment of the medication management device, the input includes at least one a button and a serial port. In an embodiment of the medication management device, the notification mechanism is at least one of a speaker, a vibrator, and a display.

In an embodiment, a medication compliance method is provided. The method includes providing a medication management device to a user, notifying the user via the medication management device that a medication should be taken, notifying the user via the medication management device that additional medication should be ordered, and enabling the user to remotely order the additional medication via the medication management device.

In an embodiment, the method includes enabling the user to remotely order the additional medication by pushing a single button on the device. The method, in an embodiment, includes programming the medication management device according to a preference of the user. In an embodiment, the method includes enabling the user to modify the preference. The method, in an embodiment, includes providing information about the medication via the medication management device, where the information is selected from the group consisting of instructions for taking the medication, side effects of the medication, long-term effects of the medication, and missed dose instructions. In an embodiment, the method includes enabling the user to communicate with a store using the medication management device.

In an embodiment, a method for generating revenue is provided. The method includes providing a medication management device to a user, prompting the user via the medication management device to purchase a product, and selling the product to the user.

In an embodiment, the method includes sending promotional information regarding the product to the user via the medication management device. The product, in an embodiment of the method, is not a medication.

In an embodiment, a method for generating revenue is provided. The method includes providing a medication management device to a user, prompting the user via the medication management device to order medication, enabling the user to order the medication via the medication management device, and selling a product to the user when the user picks up the medication.

In an embodiment, the method includes sending promotional information regarding the product to the user via the medication management device.

Additional features and advantages are described herein, and will be apparent from, the following Detailed Description and the figures.

### BRIEF DESCRIPTION OF THE FIGURES

FIG. 1 illustrates a front view of a medication management device according to an embodiment of the present invention.

FIG. 2 illustrates a back view of a medication management device according to an embodiment of the present invention.

FIG. 3 illustrates a perspective view of a medication management device according to an embodiment of the present invention.

FIG. 4 illustrates a top view of a medication storage apparatus according to an embodiment of the present invention.

FIG. 5 is a flow chart depicting steps included in method for ordering medication according to an embodiment of the present invention.

FIG. 6 is a flow chart depicting steps included in a medication compliance method according to an embodiment of the present invention.

FIG. 7 is a flow chart depicting steps included in a method for generating revenue from a medication management device according to an embodiment of the present invention.

FIG. 8 is a flow chart depicting steps included in a method for generating revenue from a medication management device according to an embodiment of the present invention.

FIG. 9 illustrates a front view of a medication management device displaying a home screen according to an embodiment of the present invention.

FIG. 10 illustrates a front view of a medication management device displaying a medication information screen according to an embodiment of the present invention.

FIG. 11 illustrates a front view of a medication management device displaying a medication notification screen according to an embodiment of the present invention.

FIG. 12 illustrates a front view of a medication management device displaying a medication confirmation screen according to an embodiment of the present invention.

FIG. 13 illustrates a front view of a medication management device displaying a medication refill notification screen according to an embodiment of the present invention.

FIG. 14 illustrates a front view of a medication management device displaying an ordering refill screen according to an embodiment of the present invention.

FIG. 15 illustrates a back view of a medication management device including a medication storage area according to an embodiment of the present invention.

### DETAILED DESCRIPTION

The present invention relates to systems for managing medication and increasing prescription drug compliance, including methods and devices for managing medication, methods for ordering medication remotely through the devices, and methods for generating revenue using these medication management systems.

As used herein, the term “medication” refers to health-related products that are generally taken on a routine basis, such as prescription medicine, over-the-counter medicine, or other pharmaceutical products. As used herein, the term “user” refers to a person taking medication or a caregiver in charge of administering the medication to or managing the medication for the person.

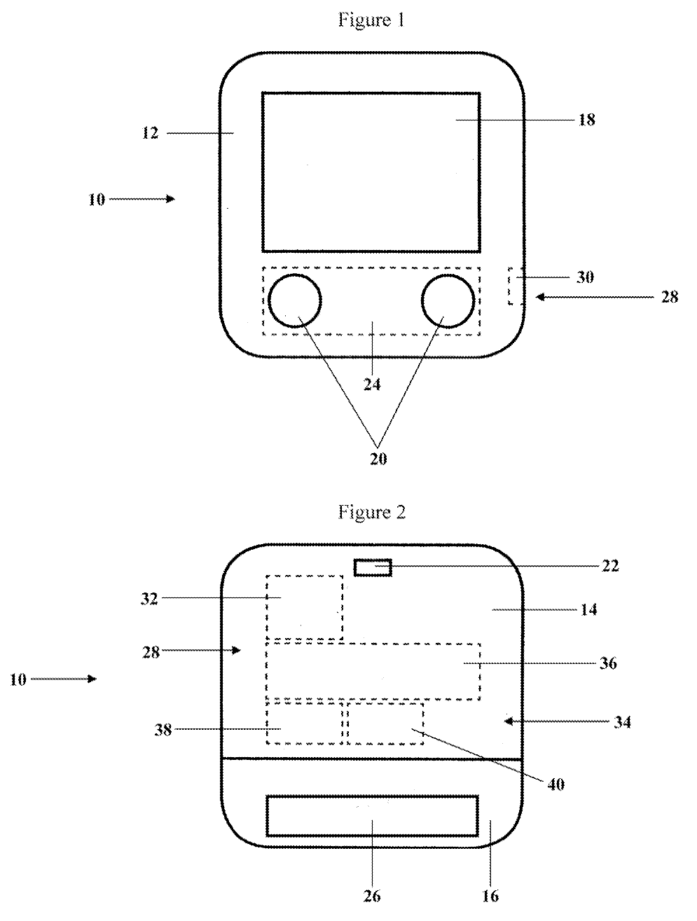

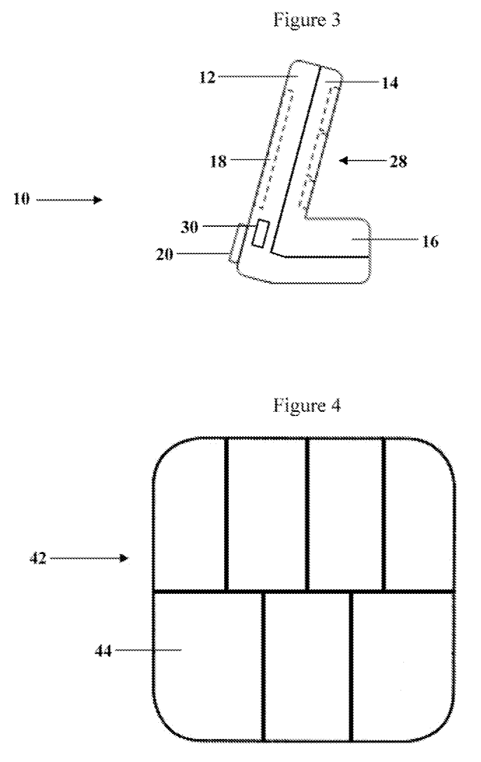

Referring to the figures, FIGS. 1, 2, and 3 represent an embodiment of the medication management device 10. The device 10 includes a front housing 12 and a back housing 14. The device 10 may also include a stand 16. FIG. 3 represents another embodiment of the device 10 including the stand 16. In this embodiment, the device 10 has an overall “L” shape. The lower portion of both the front housing 12 and the back housing 14 are curved in such a way to create a flat surface at the bottom of the device 10. This defines the stand 16 and allows the device to be used on a surface, such as a table or counter-top. Alternatively, the stand may simply be a balance piece pivotally connected to the back housing 14 which may be swung outward to support the device 10. Additional configurations for the stand 16 are possible and are within the knowledge of persons of skill in the art.

The medication management device may also include a display 18 located on the front housing 12, as depicted in the embodiments shown in FIGS. 1 and 3. The display 18 is also electrically connected to the battery 24. Messages and prompts to the user (not shown) are presented on the display 18 in the form of text and other visual graphics. To allow the user to better view the display 18, the upper portion of the front housing 12 and back housing 14 are tilted towards the stand 16 at an angle as shown in FIG. 3. Preferably, this angle is an acute angle, more preferably a 15 degree angle. Additionally, for easy readability, a large font is used for any text shown on the display 18. The size of the font used on the display 18 is preferably 16-point. Push buttons 20 are also located on the front housing 12 which allow the user to select options shown on the display 18. Preferably, the device includes at least one push button, more preferably two push buttons.

Located on the back housing 14 is an eyelet 22, which can be used to attach the device 10 to a keychain or a wall hook (not shown). Using the stand 16, the user can place the device 10 on a surface such as a tabletop or desk. The eyelet 22 enables the user to attach the device 10 to a keychain or hang it on a hook, based on his or her preference. Additional configurations for the eyelet 22 are possible and are within the knowledge of persons of skill in the art.

The front housing 12 and the back housing 14 internally house the battery 24 and the internal assembly 28. Each component of the internal assembly 28 is electrically connected to the battery 24. To replace the battery 24, the user can access it via the battery door 26, which, in this embodiment, is located on the stand 16.

The internal assembly 28 includes an input 30, a wireless transceiver 32, a notification mechanism 34, and a backlight 36. In an embodiment, the input 30 is a Universal Serial Bus (USB) port and is accessible through an opening in the front housing 12. Alternatively, the input 30 may be a FireWire port or any suitable serial port. Additional configurations for the input 30 are possible and are within the knowledge of persons of skill in the art. The input 30 allows information to be transferred into the device 10 from a remote computer. Preferably, this remote location is a store, more preferably a pharmacy. Additionally, the wireless transceiver 32 transmits and receives data between the device and a remote location.

The notification mechanism 34 is used to alert the user that it is time to take or order a medication or that a message has been received by the device 10. Possible notification mechanisms include a speaker 38 for auditory alerts or a vibrator 40 for vibratory alerts. The backlight 36 is electrically connected to the display 18 and may also be used to prompt the user with a visual alert by lighting up. The device 10 may also utilize multiple notification mechanisms, including the backlight 36, speaker 38 and vibrator 40.

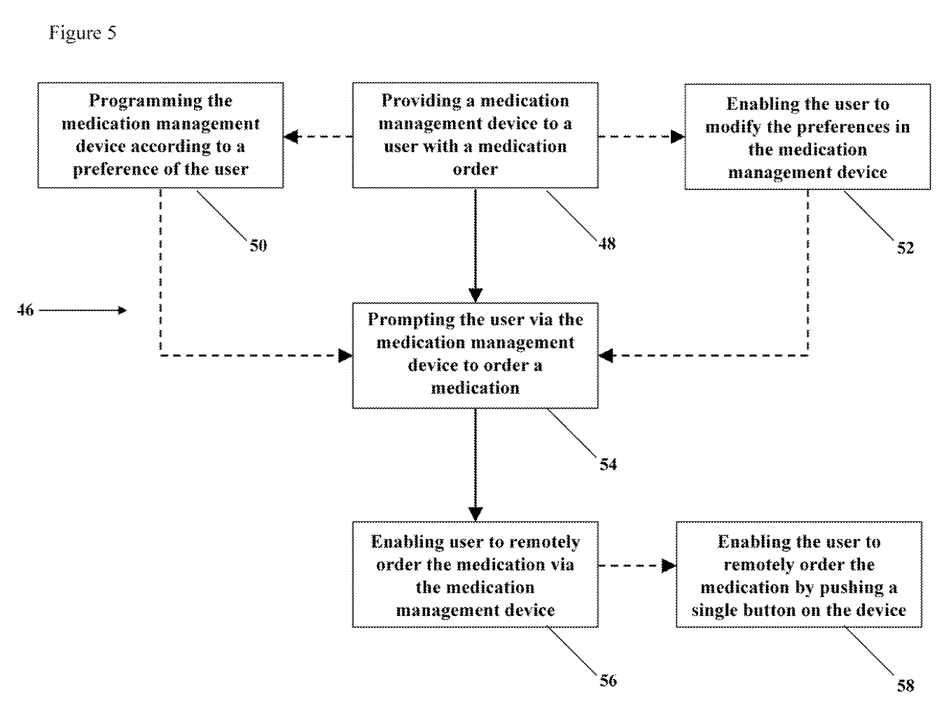

FIG. 4 shows a medication storage area 42. In an embodiment, the medication storage area 42 may be attached onto the back housing 14. Preferably, the medication storage area 42 may clip onto the back housing so that it may easily be removed from and replaced on the back housing 14. In another embodiment, the medication storage area may be integrated into the front housing 12 or the back housing 14. The medication storage area 42 enables the user to store and organize a week's supply of medication. To use the medication storage area 42, the user simply places a medication into a compartment 44 based on the daily regimen for his or her medication.

In a further embodiment, the medication storage area includes seven individual pill compartments, one for each day of the week. A primary reason for noncompliance in taking medication is that patients do not have their medication with them when they remember to take the medication. By providing the medication storage area with the medication management device, users are less likely to miss taking their medication because they will always have their medication with them.

A method for ordering medication 46 using a medication management device is shown in FIG. 5. In an embodiment, a first step 48 includes providing a medication management device to the user with a medication order. Preferably, the medication management device is the device 10 illustrated in FIGS. 1 through 4. Alternatively, the medication management device may be a traditional pager or a handheld computer. Preferably, a pharmacy would provide the medication management device to the user, however, the device could alternatively be provided at a retail store. As used herein, the phrase “providing a medication management device to a user” refers to selling the medication management device to the user with a medication order, providing the medication management device free of charge when the user purchases a medication order, or offering the medication management device to the user with a medication order on a lease basis.

In one embodiment, the medication management device may also be programmed according to a preference of the user in step 50. Preferably, the device is programmed by a medical professional who has been trained to do so, including a doctor or pharmacist. The medical professional may also delete, add, or modify medication information stored on the device in accordance with applicable laws. In the present embodiment, the device is programmed by entering the user's preferred medication reminder times and formats. Options for reminder formats in the present embodiment include any combination of light, sound and vibration. Options for reminder times are preferably in 15 minute increments, for every hour of the day, and for every day of the week. In an additional embodiment, the method further includes the step 52 of enabling the user to modify these preferences.

Next, the medication management device prompts the user to order additional medication in step 54. In an embodiment, the user may be prompted by a message displayed on the medication management device to order additional medication. This message could be in the form of text or a graphical image. Additionally, a notification mechanism may also be used to notify the user that additional medication should be ordered. In step 56, after being prompted to do so, the user may remotely order the medication via the medication management device. Preferably, the user may remotely order the medication by pushing a single button on the medication management device as shown in step 58.

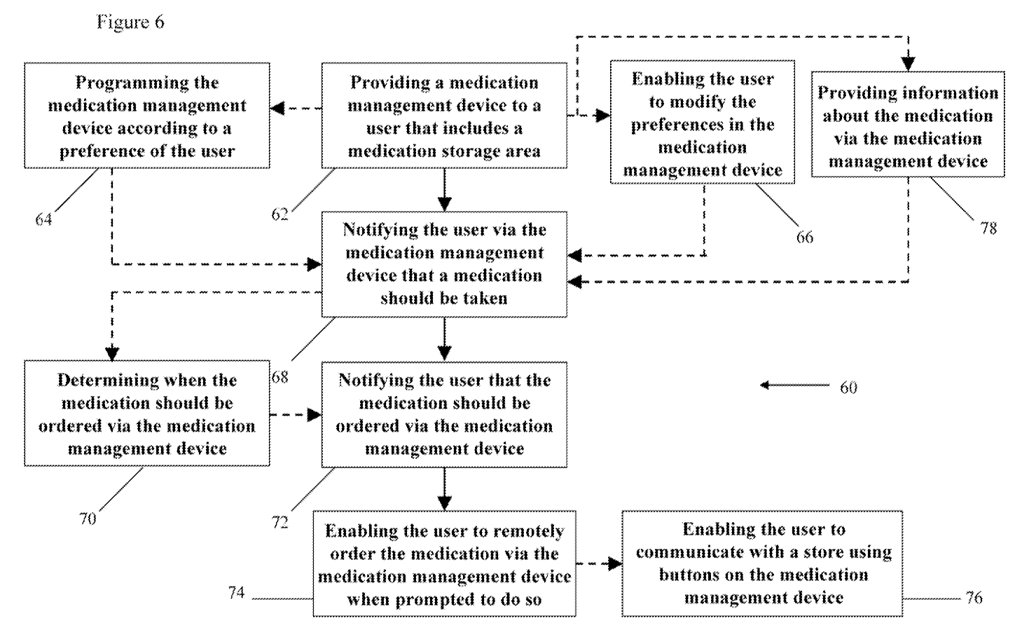

FIG. 6 illustrates a medication compliance method 60 using a medication management device. In an embodiment of the method 60, a user is provided with a medication management device as shown in step 62. Preferably, the medication management device is the device illustrated in FIGS. 1 through 4. Alternatively, the medication management device may be a traditional pager or a handheld computer. In an alternative step 64, the medication management device is programmed according to a preference of the user. The preference may include preferred medication reminder times and formats, including a time of day that the user should be notified that a medication should be taken and a type of notification.

In an optional step 66, the user may modify the preference in the medication management device. Initially, a home screen will be displayed on the medication management device. The home screen preferably includes the date and time and two options: “Pill Info” and “Setup”. Preferably, the user may manually change the time and alert preferences after they are initially programmed by selecting an input, such as a button, corresponding to the “Setup” option on the home screen. The user is then notified in step 68 via the medication management device that a medication should be taken. The user may be notified via any combination of a speaker, a backlight, and a vibrator.

In alternate step 70, the medication management device then determines when a medication should be ordered. This may be done by simply choosing a date or time to notify the user that a medication should be ordered or re-ordered. Preferably, step 70 is performed by determining first how many times a medication should be taken before it should be re-ordered. The medication management device determines whether a medication has been taken based on whether a user selects a “Now” option displayed on the medication management device. Preferably, the user selects an input, such as a button, corresponding to the “Now” option. Finally, the number of times remaining to take the medication is determined. Preferably, this is calculated by subtracting the total number of times that the user has selected the “Now” option for a given medication from the number of times that a medication should be taken before it should be re-ordered. If the number of times is less than or equal to a predetermined value, the medication management device determines that a medication should be re-ordered. For example, the pre-determined value may be set to five for a daily medication in order to give the user five days' notice that the medication should be re-ordered before the medication runs out.

In step 72, the user is notified that a medication should be ordered via the medication management device. The user may be notified via a notification mechanism, such as any combination of a speaker, a backlight, or a vibrator. Preferably, the user is notified using a text message shown displayed on the medication management device in conjunction with notification mechanism.

In step 74, the user may remotely order the medication via the medication management device after being notified in step 72. Preferably, the user may choose to immediately order a medication by pressing selecting an input, such as a button, corresponding to a “Now” option displayed on the medication management device. The user may also delay ordering a refill by choosing a “Later” option displayed on the medication management device. More preferably, if the user chooses to immediately order a medication, the medication management device will prompt the user to schedule a time to come and pick up the medication. If the user chooses to order the medication, the medication management device will then remotely communicate with a store using a wireless transceiver and place an order for the medication. Once the medication is ordered, the store communicates to the user, preferably through the medication management device, that his or her order is ready.

In an alternative step 76, the user is enabled to communicate with a store by selecting an input, such as a button, on the medication management device. This communication could include scheduling a time for the user to come and pick up the additional ordered medication. The medication management device may send and receive messages from the pharmacy or store utilizing a wireless transceiver which communicates, for example, through a pager or cellular phone network, or through the internet.

In a further embodiment, the user is provided with information about the medication in step 78. Preferably, information is included about every medication that the user wishes to manage with the medication management device. The information may include instructions on taking the medication, side effects and long-term effects of the medication, as well as missed dose instructions. The user can access and read this additional information by selecting an input, such as a button, corresponding to the “Pill Info” option on the home screen.

The medication management device and corresponding method may increase medication compliance by keeping track of when a medication has been taken and determining when the medication should be ordered or re-ordered. In this regard, people do not have to remember when to take their medication; the device will remind them. Educating users about their medication may also increase compliance. In this regard, the medication management device in an embodiment provides information about a medication, such as instructions on how to take the medication, side effects, and the importance of taking the medication at the same time every day.

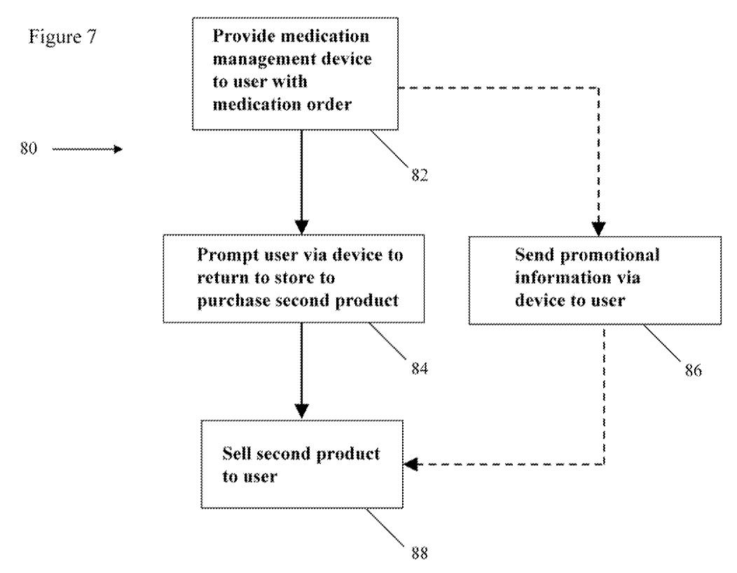

FIG. 7 illustrates a method for generating revenue 80 for a store using a medication management device. In an embodiment, a user is provided with a medication management device with a first medication order in step 82. Preferably, the user is provided with the medication management device free of charge or on a lease basis. More preferably, the device is sold to the user, with the medication order, or separate from the medication order. As shown in step 84, the user is then prompted via the medication management device to return to the store to purchase a second product from the store. In alternative step 86, promotional information is sent to the user via the medication management device. Preferably, this promotional information includes advertisements or notifications of in-store events. In step 88, the second product is then sold to the user.

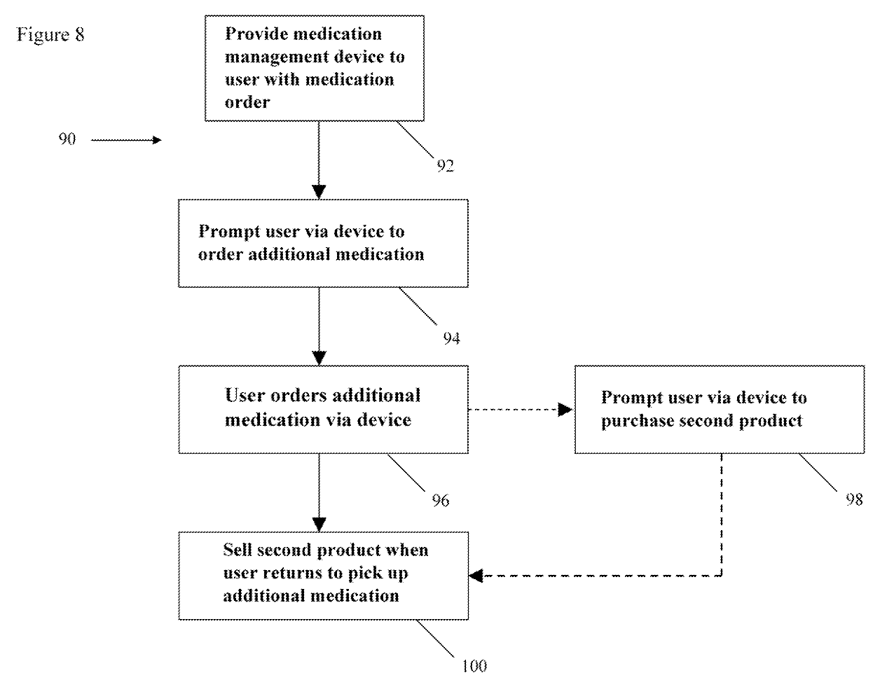

FIG. 8 illustrates a method for generating revenue 90 for a store using a medication management device. In step 92, a medication management device 10 is provided to the user with a medication order. Preferably, the user is provided with the medication management device free of charge or on a lease basis. More preferably, the device is sold to the user, with the medication order, or separate from the medication order. In step 94, the user is then prompted via the medication management device to order additional medication. Preferably, this additional medication is a refill of the first medication. In step 96, the user orders the additional medication via the medication management device. In alternative step 98, the user is prompted via the medication management device to purchase a second product from the store. Preferably, the user is prompted by sending promotional information via the medication management device. More preferably, the promotional information is in the form of advertisements or notification of in-store events. In step 100, the second product is sold to the user when the user returns to the store to pick up the additional medication.

A store induces the user to come into the store to pick up a medication order by enabling the user to easily order the medication via the medication management device. When the user is in the store, he or she may see other products and purchase those products. Additionally, the store may send promotional information through the medication management device to also induce users to return to the store. In this manner, the medication management device generates revenue not just from the medication that is ordered but also from other products that may be sold when the user enters the store to pick up the medication. In addition, the medication management device may increase user loyalty to the store and generate additional revenue.

Referring now to FIGS. 9 to 16, embodiments of medication management device 10 are illustrated. FIG. 9 illustrates an embodiment of medication management device 10 in which display 18 displays a home screen. The home screen includes the day and time and two options: “Pill Info” and “Setup”. The user may manually change options for medication management device 10, such as time and alert preferences, by pressing the button 20 corresponding to the “Setup” option.

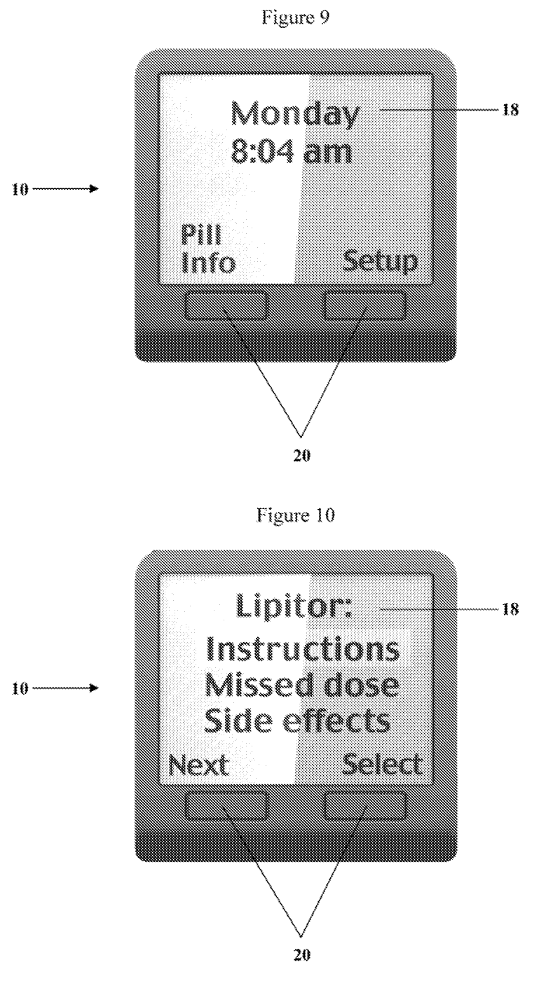

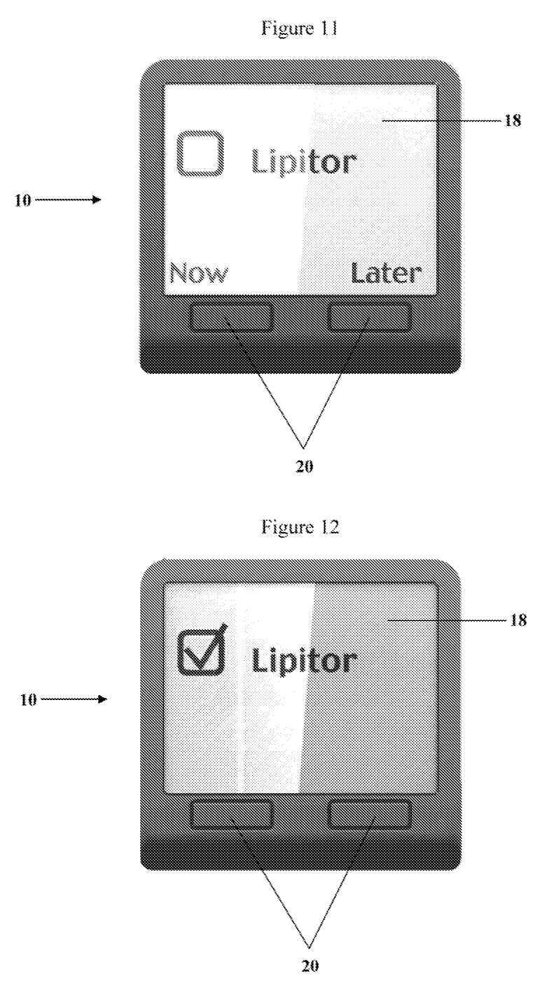

The user may also press the button 20 corresponding to the “Pill Info” option to obtain medication information. In an embodiment, when the user presses the button 20 corresponding to the “Pill Info” option, the display 18 displays a medication information screen as shown in FIG. 10. The medication information screen includes the brand name of the medication, which, in this embodiment and in the embodiments shown in FIGS. 11 to 13, is Lipitor. It should be appreciated that the generic name for the medication could be displayed in addition to or instead of the brand name. In an embodiment, medication management device 10 is configured with information regarding more than one medication. Thus, displaying at least one the brand name and the generic name of the medication enables a user to differentiate between different medications. Alternatively, neither the brand name nor the generic name of the medication is displayed.

The medication information screen as shown in the embodiment in FIG. 10 also includes three medication information options: “Instructions”, “Missed dose” and “Side effects.” The “Instructions” option includes instruction for taking the medication, the “Missed dose” option includes information for when a user misses a medication dose, and the “Side effects” option includes information regarding possible side effects of the medication. To access the medication information options, the user presses the button 20 corresponding to the “Next” option until the desired medication information option is highlighted on display 18. The “Instructions” option is highlighted in FIG. 10. To activate the highlighted medication information option, the user presses the button 20 corresponding to the “Select” option. The medication management device 10 then displays the information corresponding to the selected medication information option.

Referring now to FIG. 11, an embodiment of medication management device 10 is shown in which display 18 displays a medication notification screen. The medication notification screen notifies the user that a medication should be taken. The user is notified to take the medication by the text message “□ Lipitor” shown on display 18. In addition to the text message, the user may also be notified via a notification mechanism, such as any combination of a speaker, a backlight, or a vibrator. If the user does not wish to take the medication when notified, the user can press the button 20 corresponding to the “Later” option. If the user presses the button 20 corresponding to the “Later” option, the user will again be notified to take the medication at a predetermined time thereafter. If the user takes the medication when notified, the user presses the button 20 corresponding to the “Now” option. Pressing the button 20 corresponding to the “Now” option, in an embodiment, causes a medication confirmation screen to be displayed on display 18 as shown in FIG. 12.

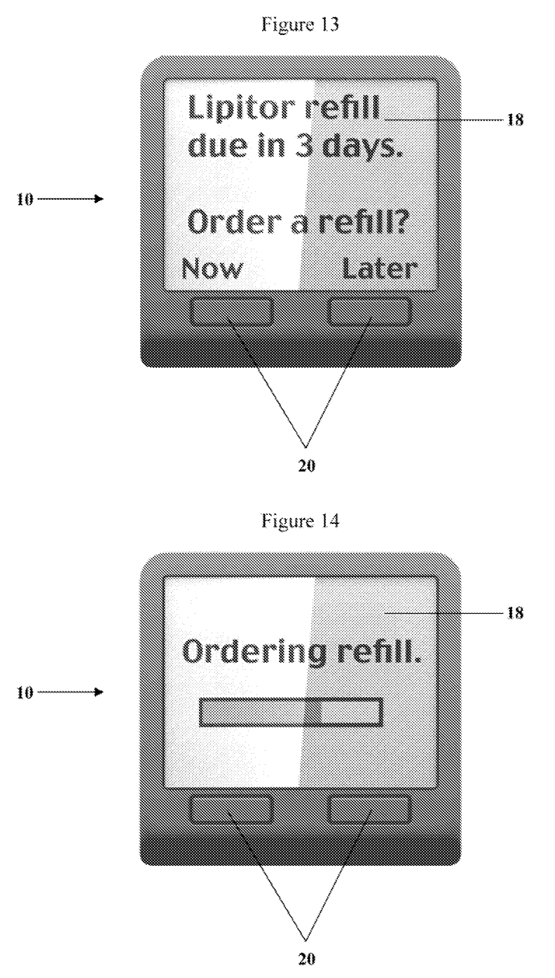

Referring now to FIG. 13, an embodiment of medication management device 10 is shown in which display 18 displays a medication refill notification screen. The medication refill notification screen notifies the user that a medication order should be refilled. In this embodiment, the user is notified that the refill is due in three days. If the user does not wish to order the medication refill when notified, the user can press the button 20 corresponding to the “Later” option. If the user presses the button 20 corresponding to the “Later” option, the user will again be notified to order the medication refill at a predetermined time thereafter. If the user presses the button 20 corresponding to the “Now” option, the medication refill order will be placed as described herein. Pressing the button 20 corresponding to the “Now” option, in an embodiment, causes an ordering refill screen to be displayed on display 18 as shown in FIG. 14. After the refill order has been placed, the display 18 in an embodiment displays an order confirmation screen (not shown). The order confirmation screen notifies the user when the refill will be ready for pickup and includes, for example, the date and time the refill will be ready.

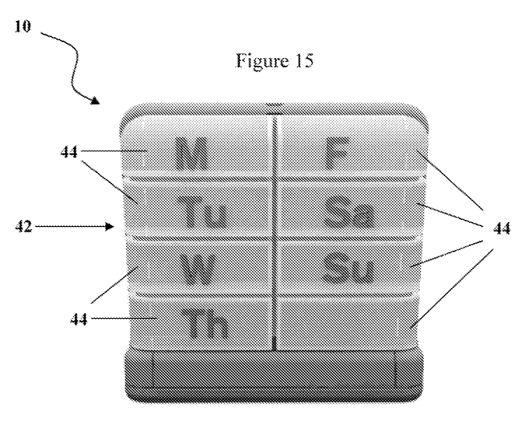

Referring now to FIG. 15, an embodiment of medication management device 10 is shown which includes a medication storage area 42. The medication storage area 42 is attached to a rear portion of medication management device 10. The medication storage area 42 includes eight compartments 44. Seven of the compartments 44 are labeled with abbreviations for each day of the week.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A method comprising:
providing a medication management device to a user;
prompting the user via the medication management device to order medication; and
enabling the user to remotely order the medication via the medication management device.

2. The method of claim 1, which includes enabling the user to remotely order the medication by pushing a single button on the medication management device.

3. The method of claim 1, which includes programming the medication management device according to a preference of the user.

4. The method of claim 3, which includes enabling the user to modify the preference.

5. The method of claim 1, which includes programming the medication management device with preferred medication reminder times and formats.

6. A medication management device comprising:
a housing;
an input;
a wireless transceiver;
a notification mechanism; and
a medication storage area.

7. The device of claim 6, which includes an eyelet.

8. The device of claim 6, wherein the input includes at least one a button and a serial port.

9. The device of claim 6, wherein the notification mechanism is at least one of a speaker, a vibrator, and a display.

10. A method comprising:
providing a medication management device to a user;
notifying the user via the medication management device that a medication should be taken;
notifying the user via the medication management device that additional medication should be ordered; and
enabling the user to remotely order the additional medication via the medication management device.

11. The method of claim 10, which includes enabling the user to remotely order the additional medication by pushing a single button on the device.

12. The method of claim 10, which includes programming the medication management device according to a preference of the user.

13. The method of claim 12, which includes enabling the user to modify the preference.

14. The method of claim 10, which includes providing information about the medication via the medication management device, where the information is selected from the group consisting of instructions for taking the medication, side effects of the medication, long-term effects of the medication, and missed dose instructions.

15. The method of claim 10, which includes enabling the user to communicate with a store using the medication management device.

16. A method comprising:
providing a medication management device to a user;
prompting the user via the medication management device to purchase a product; and
selling the product to the user.

17. The method of claim 16, which includes sending promotional information regarding the product to the user via the medication management device.

18. The method of claim 16, wherein the product is not a medication.

19. A method comprising:
providing a medication management device to a user;
prompting the user via the medication management device to order medication;
enabling the user to order the medication via the medication management device; and
selling a product to the user when the user picks up the medication.

20. The method of claim 19, which includes sending promotional information regarding the product to the user via the medication management device.
